(19) United States
(12) Patent Application Publication
(10) Pub. No.: US 2026/0210163 A1
(43) Pub. Date: Jul. 23, 2026

(54) FENESTRATION LOCK ASSEMBLY INCLUDING FENESTRATION UNIT COMPONENT

(71) Applicant: ANDERSEN CORPORATION, Bayport, MN (US)

(72) Inventors: Ryan MOHS, Woodbury, MN (US); Ross MCGRUDER, Lake Elmo, MN (US); Spencer WILENIUS, Blaine, MN (US)

(21) Appl. No.: 19/448,167

(22) Filed: Jan. 14, 2026

Related U.S. Application Data
(60) Provisional application No. 63/746,306, filed on Jan. 17, 2025.

(51) Int. Cl. E05C 3/04; E05B 65/08

(52) U.S. Cl. CPC E05C 3/041; E05B 65/0864

(57) ABSTRACT

Various embodiments of a fenestration unit component that is configured for adjustment along an adjustment axis are disclosed. The unit includes a base configured for attachment to a fenestration unit frame member, a first fastener opening extending through the base, and a second fastener opening extending through the base. The first fastener opening and the second fastener opening are aligned with each other along the adjustment axis that extends through the first fastener opening and the second fastener opening. The unit further includes a placement insert located and retained in the first fastener opening, where the insert includes a placement opening defining a fixed center within the first fastener opening. The placement opening is smaller than the first fastener opening. Further, the placement opening defines a fastener axis extending through the fixed center of the placement opening.

This application claims the benefit of U.S. Provisional Application No. 63/746,306, filed Jan. 17, 2025, the disclosure of which is incorporated by reference herein in its entirety.

Fenestration lock assemblies, fenestration unit components, and methods of assembling and adjusting the same are described herein.

Lock assemblies used in fenestration units often use rotating cams that are captured by keepers. One potential drawback of such lock assemblies is the need for precise alignment between the rotating cam and the keeper. The alignment requirements may be difficult and/or expensive to achieve. Examples of such lock assemblies may be found in, e.g., U.S. Pat. Nos. 3,811,718; 4,095,829; 5,582,445; etc.

### SUMMARY

Fenestration lock assemblies, fenestration unit components, and methods of assembling and adjusting the same are described herein.

In one or more embodiments, the fenestration lock assemblies described herein may be used to secure a first frame member or sash of a fenestration unit (e.g., a window) to a fenestration unit component (e.g., a keeper) attached to a second frame member or sash of the fenestration unit and thereby prevent movement of the first and second frame members relative to each other in a manner that would open the window on which the fenestration lock assembly is mounted. For example, a lock assembly can be mounted to a top rail of a lower operable sash, and a keeper can be mounted to a bottom rail of an upper operable sash. Locking a cam of the lock assembly into the keeper can prevent movement of the upper and lower sashes relative to each other. In one or more embodiments, the fenestration unit component can be a first fenestration unit component that is a part of a fenestration lock system that also includes a second fenestration unit component. For example, the first fenestration unit component can be a keeper, and the second fenestration unit component can be a lock assembly. A base of the first fenestration unit component can be configured for attachment to a first fenestration unit frame member (e.g., upper sash), and a base of the second fenestration unit component can be configured for attachment to a second fenestration unit frame member (e.g., lower sash). The first fenestration unit component can be configured to engage with the second fenestration unit component to lock the first fenestration unit frame member and the second fenestration unit frame member in their closed positions.

The fenestration unit component can include a base and a placement insert inserted into a fastener opening of the base, where the base is configured for attachment to the fenestration unit frame member. The placement insert can be utilized during factory assembly of the fenestration unit as a keeper datum that is aligned with a pre-drilled hole in the fenestration unit frame member. The placement insert can align a major axis of the fastener opening with an axis of the pre-drilled hole to provide alignment of the fastener opening and the hole axis so that the fenestration unit component is located in a desired position during factory assembly.

In one aspect, the present disclosure provides a fenestration unit component configured for adjustment along an adjustment axis. The fenestration unit component includes a base configured for attachment to a fenestration unit frame member; a first fastener opening extending through the base, where the first fastener opening includes an elongated opening having a major axis and a minor axis, and where the major axis is longer than the minor axis; and a second fastener opening extending through the base. The second fastener opening includes an elongated opening having a major axis and a minor axis, where the major axis is longer than the minor axis, and where the first fastener opening and the second fastener opening are aligned with each other along an opening axis that extends through the first fastener opening and the second fastener opening. The fenestration unit component further includes a placement insert located and retained in the first fastener opening. The placement insert includes a placement opening defining a fixed center within the first fastener opening, where the placement opening is smaller than the first fastener opening, and where the placement opening defines a fastener axis extending through the fixed center of the placement opening.

In one or more embodiments of fenestration unit components described herein, the placement insert is releasably retained in the first fastener opening.

In one or more embodiments of fenestration unit components described herein, the placement insert is retained in the first fastener opening by friction between the placement insert and the first fastener opening.

In one or more embodiments of fenestration unit components described herein, the placement insert is retained in the first fastener opening by a mechanical interlock between the placement insert and the first fastener opening.

In one or more embodiments of fenestration unit components described herein, the placement opening includes a circular opening extending through the placement insert.

In one or more embodiments of fenestration unit components described herein, the first fastener opening and the second fastener opening include different shapes such that the placement insert cannot be located and retained in the second fastener opening.

In one or more embodiments of fenestration unit components described herein, the fixed center of the placement opening is located proximate a midpoint of the major axis of the first fastener opening.

In one or more embodiments of fenestration unit components described herein, the base includes a lower surface and an upper surface, wherein the lower surface is configured to face the fenestration unit frame member and the upper surface is configured to face away from the fenestration unit frame member, and wherein the first fastener opening and the second fastener opening each define a stadium shape on the upper surface of the base.

In one or more embodiments of fenestration unit components described herein, the stadium shape of the first fastener opening and the stadium shape of the second fastener opening are symmetric relative to the opening axis.

In one or more embodiments of fenestration unit components described herein, the first fastener opening tapers to a first passage formed through the base when moving from the upper surface towards the lower surface, where the first passage is asymmetric relative to the opening axis.

In one or more embodiments of fenestration unit components described herein, the second fastener opening tapers to a second passage formed through the base when moving from the upper surface towards the lower surface, where the second passage is symmetric relative to the opening axis.

In one or more embodiments of fenestration unit components described herein, the second passage includes a stadium shape.

In one or more embodiments of fenestration unit components described herein, the fenestration unit component includes one of a keeper, lock assembly, strike plate of a locking unit, casement hinge hardware, or casement snubber hardware.

In one or more embodiments of fenestration unit components described herein, the opening axis is parallel to the adjustment axis.

In one or more embodiments of fenestration unit components described herein, the opening axis is orthogonal to the adjustment axis.

In another aspect, the present disclosure provides a method of attaching a fenestration unit component to a surface of a fenestration unit frame member. The method includes locating a fenestration unit component on a surface of a fenestration unit frame member. The fenestration unit component includes a base configured for attachment to a fenestration unit frame member; a first fastener opening extending through the base, where the first fastener opening includes an elongated opening having a major axis and a minor axis, and where the major axis is longer than the minor axis; and a second fastener opening extending through the base, where the second fastener opening includes an elongated opening having a major axis and a minor axis, where the major axis is longer than the minor axis, and where the first fastener opening and the second fastener opening are aligned with each along an opening axis extending through the first fastener opening and the second fastener opening. The fenestration unit component further includes a placement insert located and retained in the first fastener opening. The placement insert includes a placement opening defining a fixed center within the placement opening. Further, the placement opening is smaller than the first fastener opening. The method further includes advancing a first fastener through the placement opening and the first fastener opening. Advancing the first fastener includes advancing the first fastener along a fastener axis extending through the fixed center of the placement opening. The method further includes advancing a second fastener through the second fastener opening after advancing the first fastener through the placement opening and the first fastener opening.

In one or more embodiments of the methods of attaching the fenestration unit component to the surface of the fenestration unit frame member described herein, locating the fenestration unit component on the surface of the fenestration unit frame member includes aligning the placement opening of the placement insert with a selected location on the fenestration unit frame member before advancing the first fastener.

In one or more embodiments of the methods of attaching the fenestration unit component to the surface of the fenestration unit frame member described herein, aligning the placement opening of the placement insert with a selected location includes aligning the fixed center of the placement opening with the selected location.

In one or more embodiments of the methods of attaching the fenestration unit component to the surface of the fenestration unit frame member described herein, the fixed center of the placement opening is located proximate a midpoint of the major axis of the first fastener opening.

In one or more embodiments of the methods of attaching the fenestration unit component to the surface of the fenestration unit frame member described herein, the placement insert is a first placement insert. Advancing the second fastener includes advancing the second fastener through a placement opening of a second placement insert and the second opening.

In another aspect, the present disclosure provides a method of adjusting a position of a fenestration unit component on a surface of a fenestration unit frame member. The fenestration unit component includes an elongated first fastener opening extending through a base and an elongated second fastener opening extending through the base. The method includes removing a first fastener from the first fastener opening and the fenestration unit frame member, where removing the first fastener from the first fastener opening includes removing the first fastener from a placement opening of a placement insert located in the first fastener opening. The method further includes removing the placement insert from the first fastener opening after removing the first fastener from the first fastener opening, adjusting a position of the fenestration unit component along an adjustment axis, and reinserting the first fastener through the first fastener opening and into the fenestration unit frame member. The method further includes securing the fenestration unit component to the fenestration unit frame member after adjusting the position of the fenestration unit component.

In one or more embodiments of the methods of adjusting the position of the fenestration unit component on the surface of the fenestration unit frame member described herein, the method further includes removing or loosening a second fastener from the second fastener opening prior to adjusting the position of the fenestration unit component.

In one or more embodiments of the methods of adjusting the position of the fenestration unit component on the surface of the fenestration unit frame member described herein, removing the placement insert includes pushing the placement insert out of the first fastener opening.

In one or more embodiments of the methods of adjusting the position of the fenestration unit component on the surface of the fenestration unit frame member described herein, removing the placement insert includes prying the placement insert out of the first fastener opening.

In one or more embodiments of the methods of adjusting the position of the fenestration unit component on the surface of the fenestration unit frame member described herein, removing the placement insert includes releasing a mechanical interlock that is disposed between the placement insert and the base.

In one or more embodiments of the methods of adjusting the position of the fenestration unit component on the surface of the fenestration unit frame member described herein, reinserting the first fastener includes reinserting the first fastener into a bore in the fenestration unit frame member from which the first fastener was removed when removing the first fastener from the first fastener opening and the fenestration unit frame member.

In one or more embodiments of the methods of adjusting the position of the fenestration unit component on the surface of the fenestration unit frame member described herein, the placement insert is a first placement insert. The method further includes removing a second fastener from the second fastener opening prior to adjusting the position of the fenestration unit component. Removing the second fastener from the second fastener opening includes removing the second fastener from a placement opening of a second placement insert located in the second fastener opening.

In another aspect, the present disclosure provides a method of assembling a fenestration unit component. The method includes providing the fenestration unit component that includes a first fastener opening extending through a base, where the first fastener opening includes an elongated opening having a major axis and a minor axis, and where the major axis is longer than the minor axis; and a second fastener opening extending through the base, where the second fastener opening includes an elongated opening having a major axis and a minor axis, where the major axis is longer than the minor axis, and where the first fastener opening and the second fastener opening are aligned with each other along an opening axis extending through the first fastener opening and the second fastener opening. The method further includes inserting a placement insert in the first fastener opening. The placement insert includes a placement opening defining a fixed center within the placement opening. The placement opening is smaller than the first fastener opening.

In one or more embodiments of the methods of assembling the fenestration unit component described herein, the fenestration unit component includes one of a lock assembly, a keeper, strike plate of a locking unit, casement hinge hardware, or casement snubber hardware.

In one or more embodiments of the methods of assembling the fenestration unit component described herein, the placement insert is releasably retained in the first fastener opening.

In one or more embodiments of the methods of assembling the fenestration unit component described herein, the placement insert is retained in the first fastener opening by friction between the placement insert and the first fastener opening.

In one or more embodiments of the methods of assembling the fenestration unit component described herein, the placement insert is retained in the first fastener opening by a mechanical interlock between the placement insert and the first fastener opening.

In one or more embodiments of the methods of assembling the fenestration unit component described herein, the placement opening includes a circular opening extending through the placement insert.

In one or more embodiments of the methods of assembling the fenestration unit component described herein, the first fastener opening and the second fastener opening includes different shapes such that the placement insert cannot be located and retained in the second fastener opening.

In one or more embodiments of the methods of assembling the fenestration unit component described herein, the fixed center of the placement opening is located proximate a midpoint of the major axis of the first fastener opening.

In one or more embodiments of the methods of assembling the fenestration unit component described herein, the base includes a lower surface and an upper surface, where the lower surface is configured to face the fenestration unit frame member and the upper surface is configured to face away from the fenestration unit frame member, and where the first fastener opening and the second fastener opening each define a stadium shape on the upper surface of the base.

In one or more embodiments of the methods of assembling the fenestration unit component described herein, the stadium shape of the first fastener opening and the stadium shape of the second fastener opening are symmetric relative to the opening axis.

In one or more embodiments of the methods of assembling the fenestration unit component described herein, the first fastener opening tapers to a first passage formed through the base when moving from the upper surface towards the lower surface, where the first passage is asymmetric relative to the opening axis.

In one or more embodiments of the methods of assembling the fenestration unit component described herein, the second fastener opening tapers to a second passage formed through the base when moving from the upper surface towards the lower surface, where the second passage is symmetric relative to the opening axis.

In one or more embodiments of the methods of assembling the fenestration unit component described herein, the second passage includes a stadium shape.

In one or more embodiments of the methods of assembling the fenestration unit component described herein, the placement insert is a first placement insert. The method further includes inserting a second placement insert in the second fastener opening, the second placement insert including a placement opening defining a fixed center within the placement opening. Further, the placement opening is smaller than the second fastener opening.

In another aspect, the present disclosure provides a fenestration lock system that includes a first fenestration unit component and a second fenestration unit component. The first fenestration unit component is configured for adjustment along a first adjustment axis and the second fenestration unit component is configured for adjustment along a second adjustment axis, where the first adjustment axis is substantially orthogonal to the second adjustment axis. Each of the first fenestration unit component and second fenestration unit component includes a base configured for attachment to a fenestration unit frame member of a fenestration unit frame; a first fastener opening extending through the base, where the first fastener opening includes an elongated opening having a major axis and a minor axis, where the major axis is longer than the minor axis; and a second fastener opening extending through the base, where the second fastener opening including an elongated opening including a major axis and a minor axis, where the major axis is longer than the minor axis, and where the first fastener opening and the second fastener opening are aligned with each other along an opening axis. Each of the first fenestration unit component and second fenestration unit component also includes a placement insert located and retained in the first fastener opening of at least one of the first fenestration unit component or the second fenestration unit component, the placement insert including a placement opening defining a fixed center within the first fastener opening. The placement opening is smaller than the first fastener opening. Further, the placement opening defines a fastener axis extending through the fixed center of the placement opening.

In one or more embodiments of the fenestration lock system described herein, the placement insert is a first placement insert, where the system further includes a second placement insert located and retained in the second fastener opening of at least one of the first fenestration unit component or the second fenestration unit component. The second placement insert includes a placement opening defining a fixed center within the second fastener opening. The placement opening is smaller than the second fastener opening. Further, the placement opening defines a fastener axis extending through the fixed center of the placement opening.

In one or more embodiments of the fenestration lock system described herein, the first placement insert is releasably retained in the first fastener opening and the second placement insert is releasably retained in the second fastener opening.

In one or more embodiments of the fenestration lock system described herein, the first placement insert is retained in the first fastener opening by friction between the placement insert and the first fastener opening, and the second placement insert is retained in the second fastener opening by friction between the placement insert and the second fastener opening.

In one or more embodiments of the fenestration lock system described herein, the first placement insert is retained in the first fastener opening by a mechanical interlock between the first placement insert and the first fastener opening, and the second placement insert is retained in the second fastener opening by a mechanical interlock between the second placement insert and the second fastener opening.

In one or more embodiments of the fenestration lock system described herein, the base of each of the first fenestration unit component and second fenestration unit component includes a lower surface and an upper surface. The lower surface is configured to face the fenestration unit frame member and the upper surface is configured to face away from the fenestration unit frame member. Further, the first fastener opening and the second fastener opening each define a stadium shape on the upper surface of the base.

In one or more embodiments of the fenestration lock system described herein, the stadium shape of the first fastener opening and the stadium shape of the second fastener opening of at least one of the first fenestration unit component or second fenestration unit component are symmetric relative to the opening axis.

In one or more embodiments of the fenestration lock system described herein, the opening axis of the first fenestration unit component is parallel to the adjustment axis.

In one or more embodiments of the fenestration lock system described herein, the opening axis of the second fenestration unit component is orthogonal to the adjustment axis.

In one or more embodiments of the fenestration lock system described herein, the fenestration unit frame member is a first fenestration unit frame member, where the base of the first fenestration unit component is configured for attachment to the first fenestration unit frame member, and the base of the second fenestration unit component is configured for attachment to a second fenestration unit frame member.

In one or more embodiments of the fenestration lock system described herein, the first fenestration unit component is configured to engage with the second fenestration unit component to lock the first fenestration unit frame member and the second fenestration unit frame member in their closed positions.

In one or more embodiments of the fenestration lock system described herein, the first fenestration unit component includes a keeper and the second fenestration unit component includes a lock assembly.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein.

The above summary is not intended to describe each embodiment or every implementation of the fenestration unit component and related methods as described herein. Rather, a more complete understanding of the invention will become apparent and appreciated by reference to the following Description of Illustrative Embodiments and claims in view of the accompanying figures of the drawing.

### BRIEF DESCRIPTION OF THE VIEWS OF THE DRAWING

FIG. 1 is a schematic plan view of one embodiment of fenestration unit that includes one or more lock assemblies.

FIG. 2 is a schematic perspective view of a lock assembly of the fenestration unit of FIG. 1.

FIG. 3 is a schematic perspective view of one embodiment of a fenestration unit component that can be utilized with the lock assembly of the fenestration unit of FIG. 1, where the fenestration unit component includes a base, a first fastener opening extending through the base, and a second fastener opening extending through the base.

FIG. 4 is a schematic cross-section view of the first fastener opening and a placement insert disposed in the first fastener opening of the fenestration unit component of FIG. 3.

FIG. 5 is a schematic plan view of the fenestration unit component of FIG. 3 with the placement insert disposed in the first fastener opening.

FIG. 6 is a schematic plan view of the fenestration unit component of FIG. 3 with the placement insert removed from the first fastener opening.

FIG. 7 is a schematic plan view of the first fastener opening of the fenestration unit component of FIG. 3.

FIG. 8 is a schematic plan view of the second fastener opening of the fenestration unit component of FIG. 3.

FIG. 9 is a schematic cross-section view of the first fastener opening of the fenestration unit component of FIG. 3 with the placement insert of FIG. 4 located in the first fastener opening and a fastener of the fenestration unit component disposed in a placement opening of the placement insert and into the fenestration unit frame member of FIG. 2.

FIG. 10 is a schematic cross-section view of the first fastener opening of the fenestration unit component of FIG. 3 with the placement insert of FIG. 4 removed from the first fastener opening for explanatory purposes.

FIG. 11 is a schematic cross-section view of the second fastener opening of the fenestration unit component of FIG. 3.

FIG. 12 is a flowchart of one technique of attaching the fenestration unit component of FIG. 3 to the surface of the fenestration unit frame member of FIG. 2.

FIG. 13 is a flowchart of one technique of adjusting a position of the fenestration unit component of FIG. 3 to the surface of the fenestration unit frame member of FIG. 2.

FIG. 14 is a flowchart of one technique of assembling the fenestration unit component of FIG. 3.

FIG. 15 is a schematic plan view of one embodiment of a fenestration lock system that includes the fenestration unit component of FIG. 3 and a second fenestration unit component.

FIG. 16 is a schematic plan view of the fenestration lock system of FIG. 15 with a handle of the second fenestration unit component removed and the first and second fenestration unit components spaced apart for explanatory purposes.

FIG. 17 is a schematic exploded view of the second fenestration unit component of the fenestration lock system of FIG. 15.

FIG. 18 is a schematic cross-section view of the second fenestration unit component of the fenestration lock system of FIG. 15.

FIG. 19 is a schematic plan view of one embodiment of a lock unit component that includes a base, a first fastener opening extending through the base, and a second fastener opening extending through the base.

FIG. 20 is a schematic plan view of the lock unit component of FIG. 19 with a placement insert located in the first fastener opening.

### DESCRIPTION OF ILLUSTRATIVE EMBODIMENTS

In the following description of illustrative embodiments, reference is made to the accompanying figures of the drawing that form a part hereof, and in which are shown, by way of illustration, specific embodiments. It is to be understood that other embodiments may be utilized and structural changes may be made without departing from the scope of the present invention.

In general, a fenestration lock system includes a keeper located on a first fenestration unit frame member (e.g., an upper sash) of a fenestration unit and a fenestration lock assembly located on a second fenestration unit frame member (e.g., a lower sash) of the fenestration unit. The fenestration lock assembly can include a rotating cam that can be captured by the keeper to prevent the second frame member from being moved relative to the first frame member so that a window of the fenestration unit remains locked in a closed position.

The fenestration lock system may be used with a variety of different fenestration units that include movable panels with fenestration lock assemblies. Fenestration units in the form of windows may include one or more horizontally sliding panels (i.e., sashes), one or more vertically moving panels (in, e.g., a double hung window, a single hung window, etc.), and/or one or more rotating panels (in, e.g., a casement window, transom, etc.). Fenestration units in the form of doors may include one or more movable panels, which may include one or more horizontally sliding panels (e.g., patio doors, sliding doors, gliding doors, multi-glide doors, lift and slide doors, etc.), one or more vertically movable door panels, and/or one or more rotating movable panels. The movable panels in fenestration units as described herein slide and/or rotate between closed and open positions within a fenestration unit frame. The movable panels in fenestration units described herein may include glazing panels and/or opaque panels constructed of wood or other materials.

During manufacture of a fenestration unit, a pre-drilled hole that is disposed along a hole axis is typically located in a surface of the first frame member or sash, and the keeper can be fastened to the first frame member by directing a fastener through a fastener opening in a base of the keeper and along the hole axis into the pre-drilled hole so that the keeper can be aligned with the fenestration lock assembly that is located on the second frame member or sash. Because fastener openings disposed through the base of the keeper are configured to allow adjustment of the keeper during installation of the fenestration unit by sizing the opening such that it is larger than the fastener that is inserted through each fastener opening and secured in the first frame member, the keeper can become misaligned during the manufacturing process. Such misalignment can create difficulties when the fenestration unit is installed, thereby causing an installer to realign the keeper with the fenestration lock assembly, e.g., by having to dispose new drilled holes in the first frame member.

Similarly, at least one pre-drilled hole that is disposed along a hole axis is typically located in a surface of the second frame member or sash, and the lock assembly can be fastened to the second frame member by directing a fastener through a fastener opening in a base of the lock assembly and along the hole axis into the pre-drilled hole so that the lock assembly can be aligned with the keeper that is located on the first frame member or sash. As with the keeper, the lock assembly includes one or more fastener openings disposed through the base of the lock assembly that are configured to allow adjustment of the lock assembly during installation by sizing the opening such that it is larger than the fastener that is inserted through each fastener opening and secured in the second frame member, the lock assembly can become misaligned during the manufacturing process. Such misalignment can create difficulties when the fenestration unit is installed, thereby causing an installer to realign the lock assembly with the keeper, e.g., by having to dispose new drilled holes in the second frame member.

One or more embodiments of a fenestration unit component described herein that can be utilized as a lock assembly or a keeper, or in other applications, can provide various advantages over currently available lock assemblies and keepers. For example, the fenestration unit component can include a base and a placement insert that can be located and retained in a fastener opening that is disposed through the base. The placement insert can be inserted into the base during manufacture of the fenestration unit and can minimize variability during installation of a fenestration lock system to a fenestration unit. The placement insert can be utilized as a datum for the pre-drilled hole during assembly, where a placement opening of the insert can be aligned with the axis of the pre-drilled hole. This alignment can help ensure that the fenestration unit component is in a desired position relative to another fenestration unit component of the system during manufacture.

In one or more embodiments where the fenestration unit component includes a first fastener opening extending through the base and a second fastener opening also extending through the base, the placement insert and/or the first fastener opening can be configured so that the placement insert can only be located in the first fastener opening and not the second fastener opening so that the insert is aligned with the pre-drilled hole, and, therefore, can provide a datum for the position of the pre-drilled alignment hole. For example, the placement insert and the fenestration unit component are Poka-yoked to ensure that the insert can only fit in the first fastener opening that is aligned with the factory datum.

The use of one or more embodiments of fenestration unit components can eliminate the need for an elaborate manufacturing machine or process to ensure precision factory placement. Additionally, an end-of-line quality check may not be required to ensure precision factory placement of the fenestration unit component when such fenestration unit component is utilized. Further, one or more embodiments of fenestration unit components can provide end users with the ability to adjust the keeper to fenestration lock assembly relationship over the life of the product while ensuring that the product comes from the factory built to the desired design.

During installation, fenestration units may require adjustment of at least one of the lock assembly or keeper so that the lock assembly and keeper function together to lock the first and second sashes in place relative to each other. The need for service adjustability can be caused by several factors (i.e., installation, weathering, etc.). One or more embodiments of fenestration lock systems described herein can include at least one fenestration unit component (e.g., a keeper). Adjustment of the system can be accomplished through removal of the placement insert from the base of the at least one fenestration unit component. Upon removal of the placement insert, the at least one fenestration unit component can exhibit full fastener opening function and can be adjusted to properly engage a second fenestration unit component (e.g., a lock assembly) that can also be adjustable.

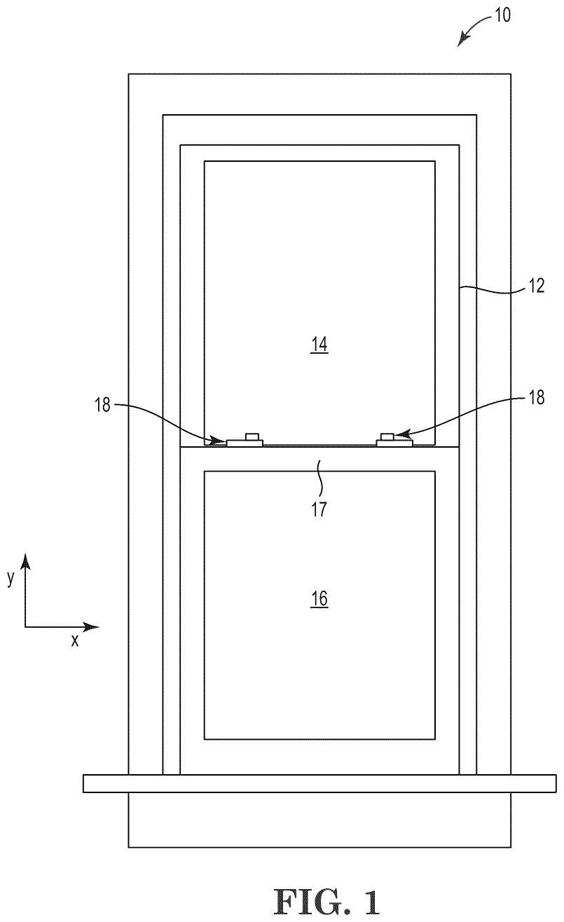

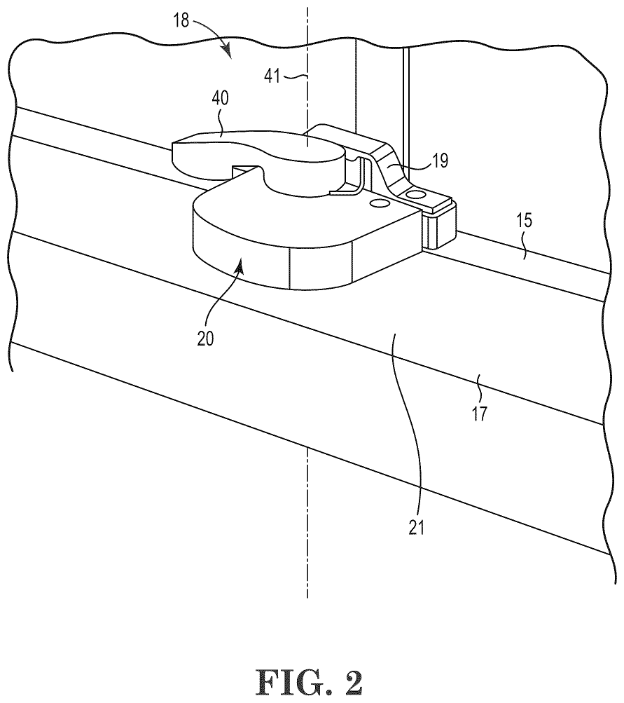

The illustrative embodiment of fenestration unit 10 depicted in FIG. 1 is in the form of a single or double hung window including a fenestration unit frame 12 along with fenestration unit frame members or upper and lower sashes 14 and 16. The upper sash 14 can be defined as a first fenestration unit frame member, and the lower sash 16 can be defined as a second fenestration unit frame member. A pair of fenestration lock systems 18 each including a keeper 19 and a lock assembly 20 are disposed on the sashes 14 and 16. At least one of the keeper 19 or the lock assembly 20 can be a fenestration unit component. In one or more embodiments, the keeper 19 can be a first fenestration unit component and the lock assembly 20 can be a second fenestration unit component. In the embodiment illustrated in FIG. 2, the keeper 19 is located on bottom rail 15 of the upper sash 14, and the lock assembly 20 is located on top rail 17 of the lower sash 16. The lock assembly 20 is configured to engage with the keeper 19 to lock the sashes in their closed positions. The fenestration unit 10 can include any suitable number of fenestration lock systems 18.

One of the fenestration lock systems 18 is depicted in an enlarged perspective view in FIG. 2 where the lock assembly 20 is mounted on top rail 17 of the lower sash 16 and includes a handle 40 configured to rotate about shaft axis 41 when moving the lock assembly between its locked and unlocked configurations. The lock assembly 20 is, in the depicted illustrative embodiment, configured to engage with a keeper 19 mounted on bottom rail 15 that forms a part of the upper sash 14 (see FIG. 1) when the sashes 14 and 16 are in their closed positions and the lock assembly is in its locked configuration. When engaged with the keeper 19, the lock assembly 20 locks the sashes 14 and 16 in their closed positions.

In one or more embodiments, all of the components of the fenestration lock systems described herein may be located on a check rail (i.e., the top rail of the lower sash and/or the bottom rail of the upper sash). In one of more alternative embodiments, the components of the fenestration lock systems described herein may be located on and/or in other portions of a fenestration unit, e.g., on and/or in another member used in the fenestration unit (e.g., a top rail, bottom rail, sill, stool, threshold, top/head jamb, side jamb, movable panel, etc.).

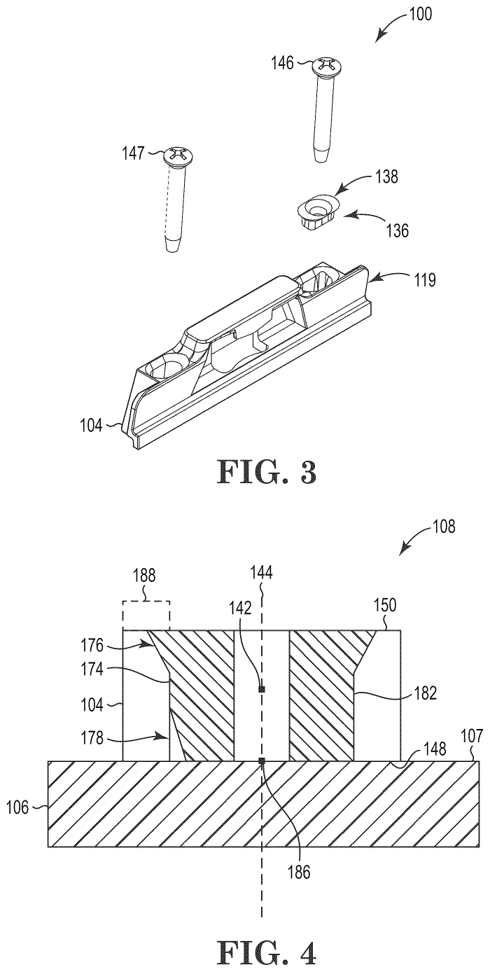

The fenestration lock systems 18 can each include any suitable fenestration unit component. For example, FIGS. 3-11 are various views of one embodiment of a fenestration unit component 100. The component 100 can be utilized in any suitable application, e.g., as at least one of a keeper (e.g., keeper 19 of FIG. 2), lock assembly (e.g., lock assembly 20 of FIG. 2), strike plate of a locking unit or lock set, casement hinge hardware, casement snubber hardware, etc., as is further described herein. In the embodiment of FIGS. 3-11, the fenestration unit component 100 is a keeper 119.

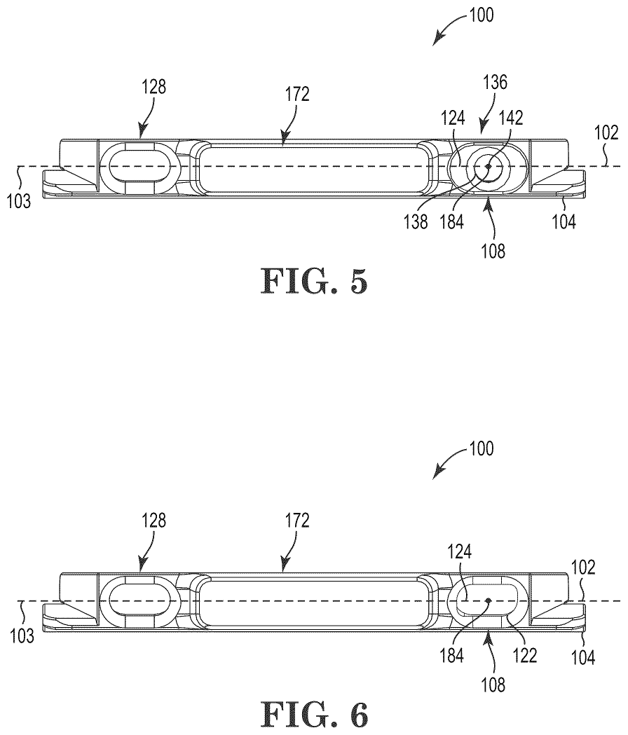

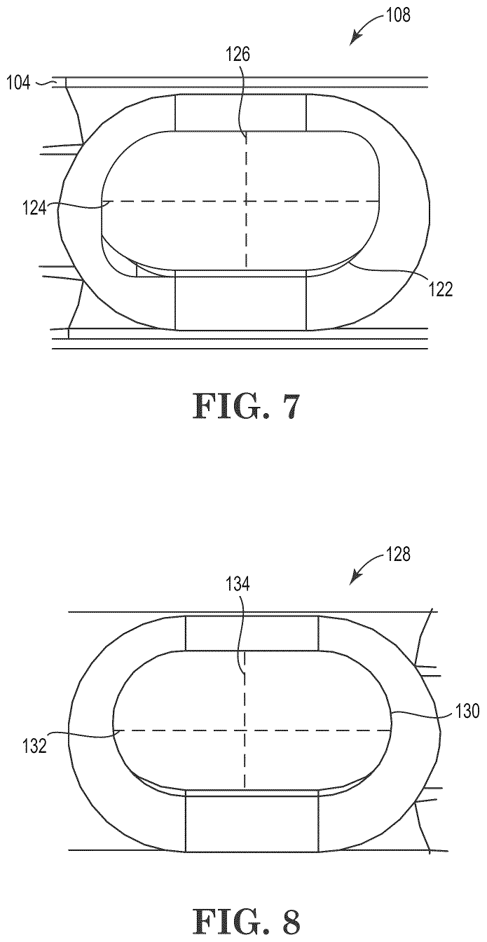

As shown in FIGS. 5-6, the fenestration unit component 100 is configured for adjustment along an adjustment axis 102. The component 100 includes a base 104 configured for attachment to a fenestration unit member 106 (FIG. 4) (e.g., bottom rail 15 of upper sash 14 of FIG. 2), and a first fastener opening 108 extending through the base, where the first fastener opening includes an elongated opening 122 (FIG. 7) that includes a major axis 124 and a minor axis 126. In one or more embodiments, the major axis 124 is longer than the 126 minor axis. The component 100 further includes a second fastener opening 128 extending through the base 104. The second fastener opening 128 includes an elongated opening 130 (FIG. 8) that includes a major axis 132 and a minor axis 134. In one or more embodiments, the major axis 132 is longer than the minor axis 134. The first fastener opening 108 and the second fastener opening 128 are aligned with each other along an opening axis 103 (FIG. 6) that extends through the first fastener opening and the second fastener opening. In one or more embodiments, the opening axis 103 is parallel to the adjustment axis 102 as shown in FIG. 6. In one or more embodiments, the opening axis 103 is colinear with the adjustment axis as is also shown in FIG. 6. Further, in one or more embodiments, the opening axis 103 is orthogonal to the adjustment axis 102 as is further described herein.

The component 100 further includes a placement insert 136 (FIG. 3) located and retained in the first fastener opening 108 (FIG. 5). The placement insert 136 includes a placement opening 138 defining a fixed center 142 (FIG. 4) within the first fastener opening 108, where the placement opening is smaller than the first fastener opening. The placement opening 138 defines a fastener axis 144 that extends through the fixed center 142 of the placement opening.

The component 100 is configured for adjustment along the adjustment axis 102 using any suitable technique. For example, at least one of the first fastener opening 108 or the second fastener opening 128 can be configured to receive a fastener (e.g., first or second fasteners 146, 147 of FIG. 3), where the elongated opening 122 of the first fastener opening and/or the elongated opening 130 of the second fastener opening are sized so that the fastener can be fastened to the base 104 in multiple positions within these openings. As a result, the component 100 can be configured to be adjusted along the adjustment axis 102 relative to the fenestration unit frame member 106 upon which the base 104 is disposed or located, while a fastener 146 disposed in the first fastener opening 108 can remain aligned with a pre-drilled datum disposed in the fenestration unit frame member 106.

The base 104 can be configured for attachment to any suitable fenestration unit frame member or sash 106 (FIG. 4). Although described as a fenestration unit frame member or sash 106, the member can be any suitable substrate, e.g., a door frame, door jamb, cabinet frame, cabinet door, etc. For example, in embodiments where the fenestration unit component 100 is a keeper such as keeper 19 of FIGS. 1-2, the base 104 can be configured for attachment to the fenestration unit frame member or upper sash 14.

The base 104 can take any suitable shape and have any suitable dimensions. As shown in FIG. 4, the base 104 includes a lower surface 148 and an upper surface 150. The lower surface 148 can be configured to face the fenestration unit frame member 106. Further, the upper surface 150 of the base 104 can be configured to face away from the member 106. Each of the lower surface 148 and upper surface 150 can take any suitable shape. In one or more embodiments, the lower surface 148 can be substantially parallel to the upper surface 150.

The base 104 can include any suitable material, e.g., at least one of an inorganic material (e.g., metal, ceramic) or an organic material (e.g., a polymer). Suitable inorganic materials include zinc, brass, steel, aluminum, and alloys of such materials. Further, suitable organic materials may include Nylon, ABS, Delrin, Acetal, and related polymer composites.

Extending through the base 104 is the first fastener opening 108. The first fastener opening 108 can take any suitable shape and have any suitable dimensions. For example, the first fastener opening 108 can define a shape that is an ellipse, oval, or rectangle. As used herein, the term “oval” means a shape that resembles two semi circles joined by a rectangle. Suitable oval shapes can include a stadium, speed skating rink, or running track shape. In the embodiment illustrates in FIGS. 3-11, the first fastener opening 108 defines a stadium shape on the upper surface 150 of the base 104 (i.e., the shape of the elongated opening 122).

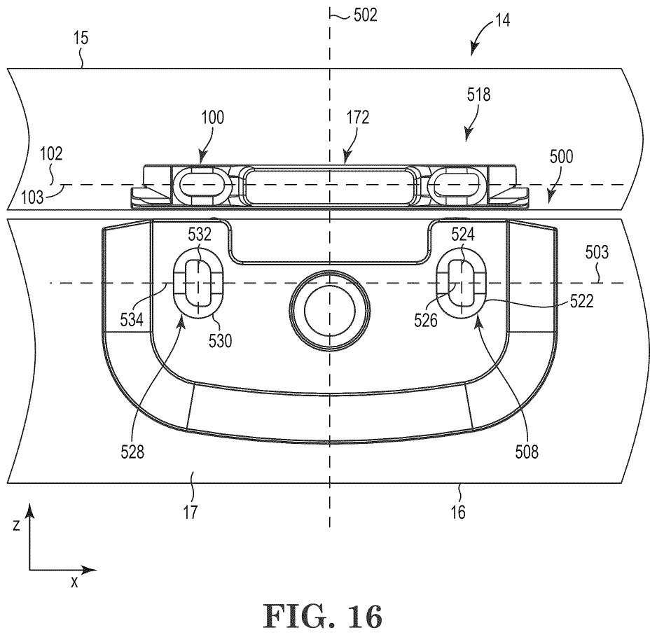

As shown in FIG. 7, which is a plan view of the first fastener opening 108, the elongated opening 122 of the first fastener opening includes the major axis 124 and the minor axis 126. The major axis 124 is longer than the minor axis 126. Each of the major and minor axes 124, 126 can have any suitable length as measured in a plane of the elongated opening 122 of the first fastener opening 108. In one or more embodiments, the major axis 124 can be substantially parallel to the opening axis 103 as shown in FIGS. 3-10. In one or more embodiments, the minor axis 126 can be substantially parallel with the opening axis 103 (see, e.g., FIG. 16). In one or more embodiments, either the major axis 124 or the minor axis 126 can be colinear with the opening axis 103.

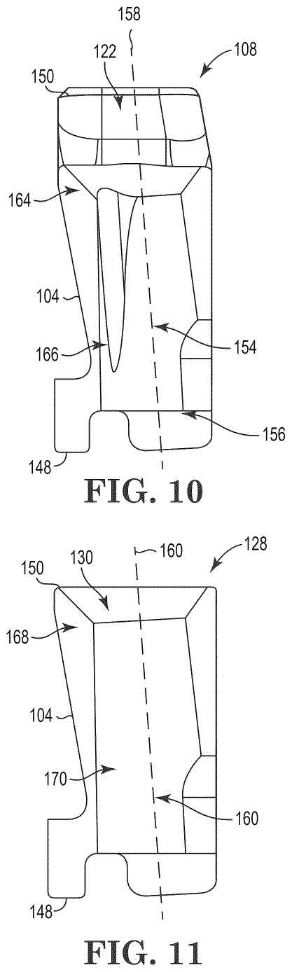

The first fastener opening 108 can taper to a first passage 154 (FIG. 10) formed through the base 104 when moving from the upper surface 150 towards the lower surface 148 of the base. FIG. 10 is a schematic cross-section view of the first fastener opening 108 with the placement insert 136 removed for explanatory purposes. In one or more embodiments, the first passage 154 can be asymmetric related to the opening axis 103 as shown in FIG. 6. In other words, the first passage 154 as projected onto a plane that is defined by the elongated opening 122 is asymmetric related to the opening axis 103. In one or more embodiments, this asymmetry of the first passage 154 can be provided by an elongated opening 156 of the first fastener opening 108 that is defined by the lower surface 148 of the base 104 that can be offset relative to the fastener axis 144, where the axis intersects a geometrical center of the elongated opening 122 of the first fastener opening 108 and is orthogonal to the plane of the elongated opening. The fastener axis 144 can form any suitable angle with the surface 107 of the fenestration unit frame member 106. In one or more embodiments, the fastener axis 144 can be substantially orthogonal to the surface 107.

The first passage 154 can have a cross-sectional area in a plane orthogonal to an axis 158 that is constant along the axis, where the axis extends through the first passage and is orthogonal to at least one of the upper surface 150 or lower surface 148 of the base 104. In one or more embodiments, the cross-sectional area of the first passage 154 can vary along the axis 158. For example, the first passage 154 can include an upper chamfered portion 164 (FIG. 10) proximate the upper surface 150 of the base 104 that has a greater cross-sectional area than a cross-sectional area of a lower portion 166 of the first passage.

Also extending through the base 104 is the second fastener opening 128, which includes the elongated opening 130. The elongated opening 130 can take any suitable shape and have any suitable dimensions, e.g., the same shapes and dimensions described herein regarding the elongated opening 122 of the first fastener opening 108. In the embodiment illustrates in FIGS. 3-11, the second fastener opening 128 (i.e., the elongated opening 130) defines a stadium shape on the upper surface 150 of the base 104.

As shown in FIG. 8, which is a plan view of the second fastener opening 128, the elongated opening 130 of the second fastener opening includes the major axis 132 and the minor axis 134. The major axis 132 is longer than the minor axis 134. Each of the major and minor axes 132, 134 can have any suitable length as measured in a plane of the elongated opening 130 of the second fastener opening 128. In one or more embodiments, the major axis 132 can be substantially parallel to the opening axis 103. In one or more embodiments, the minor axis 134 can be substantially parallel to the opening axis 103. In one or more embodiments, either the major axis 132 or the minor axis 134 can be colinear with the opening axis 103.

The second fastener opening 128 can taper to a second passage 160 (FIG. 11) formed through the base 104 when moving from the upper surface 150 towards the lower surface 148 of the base. In one or more embodiments, the second passage 160 can be symmetric related to the opening axis 103 as shown in FIG. 6. In one or more embodiments, the second passage 160 extends along an axis 162, where the axis intersects a geometrical center of the elongated opening 130 of the second fastener opening 128. In one or more embodiments, the axis 162 can form any suitable angle with the plane of the elongated opening 130. In one or more embodiments, the axis 162 can be substantially orthogonal to the plane of the elongated opening.

The second passage 160 can have a cross-sectional area in a plane orthogonal to the axis 162 that is constant along the axis. In one or more embodiments, the cross-sectional area of the second passage 160 can vary along the axis 162. For example, the second passage 160 can include an upper chamfered portion 168 proximate the upper surface 150 of the base 104 that has a greater cross-sectional area than a cross-sectional area of a lower portion 170 of the second passage.

Each of the first and second fastener openings 108, 128 can be disposed in any suitable portion or portions of the base 104. As shown in FIG. 6, the first fastener opening 108 and the second fastener opening 128 are aligned with each other along the opening axis 103, where the opening axis extends through the first fastener opening and the second fastener opening. Further, the first fastener opening 108 can be disposed any suitable distance from the second faster opening 128 along the opening axis 103. As shown in FIG. 6, a receiver portion 172 of the fenestration unit component 100, which can be configured to receive a cam of the fenestration locking assembly 20 of FIGS. 1-2, is disposed between the first fastener opening 108 and the second fastener opening 128 along the opening axis 103. The receiver portion 172 can take any suitable shape and have any suitable dimensions.

As mentioned herein, each of the first fastener opening 108 and the second faster opening 128 can take or define any suitable shape. In one or more embodiments, the first fastener opening 108 and the second fastener opening 128 include the same shape. For example, the first fastener opening 108 and the second fastener opening 128 can each define a stadium shape on the upper surface 150 of the base 104 as shown in FIG. 6. As shown, the stadium shape of the first fastener opening 108 and the stadium shape of the second fastener opening 128 are symmetric relative to the opening axis 103. In one or more embodiments, the first fastener opening 108 can define a shape that is different from a shape defined by the second fastener opening 128, and the placement insert 136 can be shaped so that it can be located and retained in the first fastener opening but not in the second fastener opening as is further described herein.

The fenestration unit component 100 further includes the placement insert 136. The placement insert 136 can be located and retained in at least one of the first fastener opening 108 or the second fastener opening 128. In the embodiment illustrated in FIGS. 3-11, the placement insert 136 is located and retained in the first fastener opening 108 as shown, e.g., in FIG. 5. Although depicted as including one placement insert 136, the component 100 can include a second placement insert that can be located and retained in the second fastener opening 128 as is further described herein.

The placement insert 136 includes the placement opening 138 that defines the fixed center 142 within the first fastener opening 108 as is also shown in FIG. 5. The placement opening 138 defines the fastener axis 144 as shown in FIG. 4. The fastener axis 144 extends through the fixed center 142 of the placement opening 138.

The placement insert 136 can include any suitable material, e.g., at least one of an inorganic material (e.g., metal or ceramic) or an organic material (e.g., polymer). Suitable organic materials include at least one of Nylon, ABS, Delrin, Acetal, and related polymer composites.

Further, the placement insert 136 can take any suitable shape and have any suitable dimensions. In one or more embodiments, the placement insert 136 can take a shape that is substantially similar to a shape of an inner surface 174 of the first fastener opening 108 as shown in FIG. 4, which is a cross-section view of the first fastener opening of the base 104 and the placement insert located and retained in the first fastener opening. In such embodiments, the placement insert 136 can be configured to substantially fill the first passage 154 of the first fastener opening 108 such that the placement insert is in contact with a substantial portion of the inner surface 174 of the first passage.

The placement insert 136 can have a cross-sectional area in a plane orthogonal to the fastener axis 144 that is constant along the fastener axis. In one or more embodiments, e.g., the embodiment shown in FIG. 4, the placement insert 136 has a cross-sectional area that varies along the fastener axis 144. For example, the placement insert 136 can include a chamfered portion 176 proximate the upper surface 150 of the base 104 when the insert is located in the first fastener opening, and a lower portion 178 of the placement insert proximate the lower surface 148 of the base can have a constant cross-sectional area along the fastener axis 144.

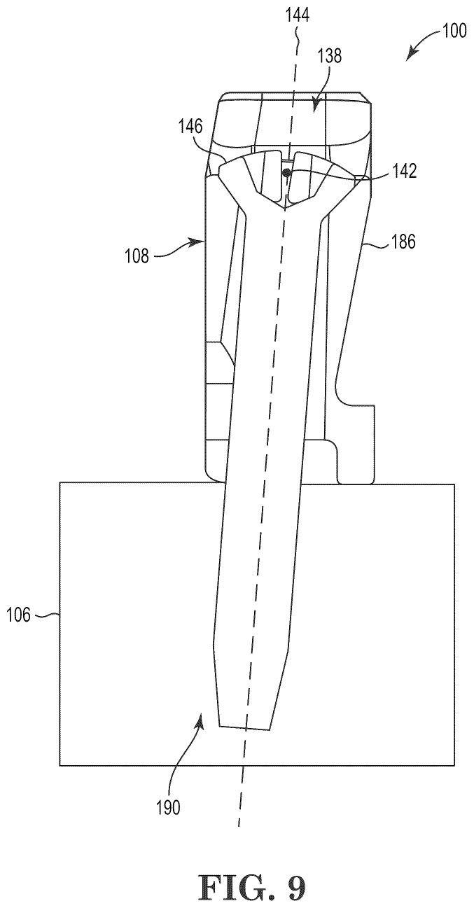

The placement opening 138 of the placement insert 136 can have any suitable dimensions. In one or more embodiments, the placement opening 138 can have a cross-sectional area that is configured to receive the first fastener 146 and retain the fastener as shown in FIG. 9. In one or more embodiments, the placement opening 138 can be configured so that it has a smaller cross-sectional area than a cross-sectional area of at least a portion of the fastener 146 so that the placement insert 136 expands and grips the fastener when the fastener is driven through the placement opening and into the fenestration unit frame member 106. Further, the placement opening 138 can have any suitable dimensions relative to the first fastener opening 108. In one or more embodiments, the placement opening 138 is smaller than the first fastener opening 108.

In one or more embodiments, the second fastener opening 128 can be configured to receive a second faster 147 (FIG. 3) and retain the second fastener as the second fastener is driven through the second fastener opening and into the fenestration unit frame member 106. Each of the first and second fasteners 146, 147 can include any suitable mechanical fastener, e.g., a screw (flat or Phillips head), nail, braid, staple, pin, Torx, and any related screw driving components.

The placement opening 138 can take any suitable cross-sectional shape, e.g., elliptical, rectangular, polygonal, etc. In one or more embodiments, the placement opening 138 includes a circular opening that extends through the placement insert 136 as shown in FIG. 4. In one or more embodiments, the placement opening 138 can have a multi-pointed star shaped cross-section that is configured to grip the fastener 146 as the fastener is driven through the placement opening and into the fenestration unit frame member 106.

The placement insert 136 can be retained in the first fastener opening 108 using any suitable technique. In one or more embodiments, the placement insert 136 is releasably retained in the first fastener opening 108. As used herein, the phrase “releasably retained” means that the placement insert 136 is retained in the first fastener opening 108 during handling and placement of the fenestration unit component 100 and that can be removed without cosmetic damage to the base 104 of the fenestration unit component 100. For example, the placement insert 136 can form a releasable interference fit with the first fastener opening 108 to retain the placement insert in the opening.

In one or more embodiments, the placement insert 136 is retained in the first fastener opening 108 by friction between the placement insert and the first fastener opening. For example, the placement insert 136 can take a shape and have dimensions such that an outer surface 182 of the placement insert is in contact with the inner surface 174 of the first passage 154 of the first fastener opening 108 as shown in FIG. 9. In one or more embodiments, the placement insert 136 is retained in the first fastener opening 108 by a mechanical interlock 188 disposed between the placement insert and the first fastener opening. The mechanical interlock 188 is shown schematically in FIG. 4. Any suitable mechanical interlock 188 can be utilized to retain the placement insert 136 in the first fastener opening 108. For example, one or more tabs can be disposed on the outer surface 182 of the placement insert 136 that are configured to be received by one or more slots disposed in the inner surface 174 of the first passage 154 of the fastener opening 108 and provide a snap fit between the placement insert and the first fastener opening. In one or more embodiments, one or more slots can be formed on the outer surface 182 of the placement insert 136 that are configured to engage with one or more tabs disposed on the inner surface 174 of the first passage 154 of the first fastener opening 108 and provide a snap fit between the placement insert and the first fastener opening.

The placement insert 136 can be inserted into the first fastener opening 108 using any suitable technique. In one or more embodiments, the placement insert 136 is directed into the first fastener opening 108 in a direction from the upper surface 150 to the lower surface 148 of the base 104. In one or more embodiments, the placement insert 136 is directed into the first fastener opening 108 in a direction from the lower surface 148 to the upper surface 150 of the base 104.

The fixed center 142 of the placement opening 138 of the placement insert 136 can be located in any suitable position relative to the first fastener opening 108. As shown in FIG. 5, the fixed center 142 of the placement opening 138 is located proximate a midpoint 184 of the major axis 124 of the first fastener opening 108. In one or more embodiments, the major axis 124 of the first fastener opening 108 can be collinear with the opening axis 103 as shown in FIG. 6.

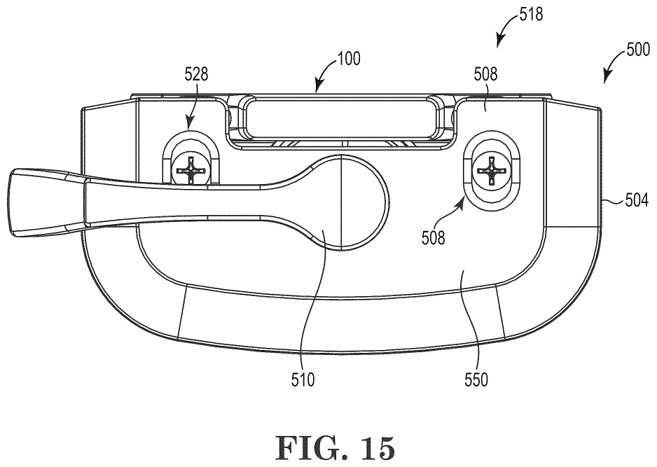

As mentioned herein, the fenestration lock system 18 can include any suitable first and second fenestration unit components 19, 20. For example, FIGS. 15-18 are various views of another embodiment of a fenestration lock system 518. All design considerations and possibilities described herein regarding fenestration lock system 18 of FIGS. 1-2 apply equally to fenestration lock system 518 of FIGS. 15-18 unless stated otherwise.

The fenestration lock system 518 includes the fenestration unit component 100 of FIGS. 3-11 and a second fenestration unit component 500. The fenestration unit component 100 is defined in the system 518 as the first fenestration unit component. Although depicted as including fenestration unit component 100 of FIGS. 3-11, the first fenestration unit component can include any suitable fenestration unit component.

The first fenestration unit component 100 is configured for adjustment along the first adjustment axis 102, and the second fenestration unit component 500 is configured for adjustment along a second adjustment axis 502. In one or more embodiments, the first adjustment axis 102 is substantially orthogonal to the second adjustment axis 502. The second fenestration unit component 500 can include any suitable fenestration unit component, e.g., fenestration unit component 100 of FIGS. 3-11. In the embodiment illustrated in FIGS. 15-18, the first fenestration unit component 100 is a keeper and the second fenestration unit component 500 is a lock assembly (e.g., lock assembly 20 of FIG. 2).

The second fenestration unit component 500 includes a base 504 configured for attachment to a fenestration unit frame member (e.g., lower sash 16), and a first fastener opening 508 extending through the base, where the first fastener opening includes an elongated opening 522 (FIG. 16) that includes a major axis 524 and a minor axis 526. In one or more embodiments, the major axis 524 is longer than the 526 minor axis. The component 500 further includes a second fastener opening 528 extending through the base 504. The second fastener opening 528 includes an elongated opening 530 (FIG. 16) that includes a major axis 532 and a minor axis 534. In one or more embodiments, the major axis 532 is longer than the minor axis 534. The first fastener opening 508 and the second fastener opening 528 are aligned with each other along an opening axis 503 that extends through the first fastener opening and the second fastener opening. In one or more embodiments, the opening axis 503 is orthogonal to the adjustment axis 502 as shown in FIG. 16.

The second fenestration unit component 500 further includes a first placement insert 536-1 located and retained in the first fastener opening 508. In one or more embodiments, the first placement insert 536-1 can be located and retained in the second fastener opening 528. In one or more embodiments, the component 500 can also include a second placement insert 536-2 located and retained in the second fastener opening 528. The first and second placement inserts 536-1 and 536-2 are collectively referred to herein as placement insert or inserts 536. The first and second placement inserts 536-1 and 536-2 can each include any suitable placement insert, e.g., placement insert 136 of FIGS. 3-11. Each placement insert 536 includes a placement opening 538 defining a fixed center 542 within the respective fastener opening 508, 528, where the placement opening is smaller than the respective fastener opening. The placement opening 538 defines a fastener axis 544 that extends through the fixed center 542 of the placement opening.

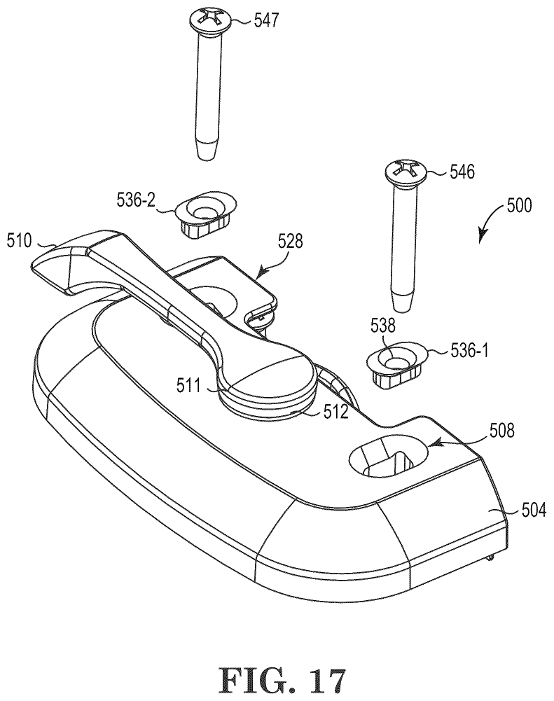

The second fenestration unit component 500 further includes a handle 510 that is connected to a cam 512 (FIG. 17) that is configured to engage the receiver portion 172 of the first fenestration unit component 100.

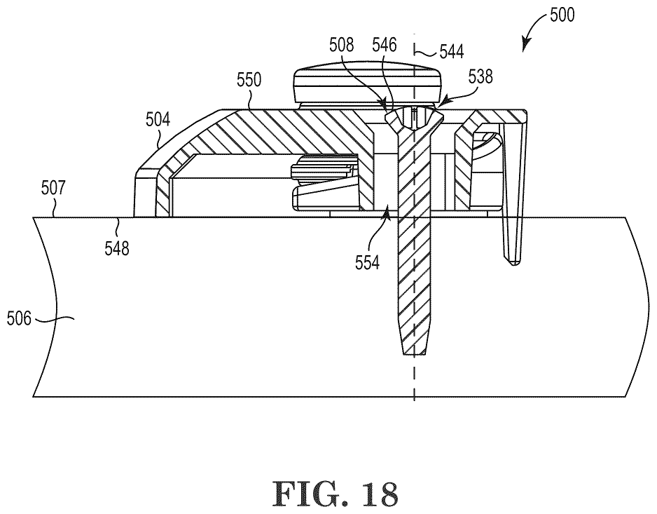

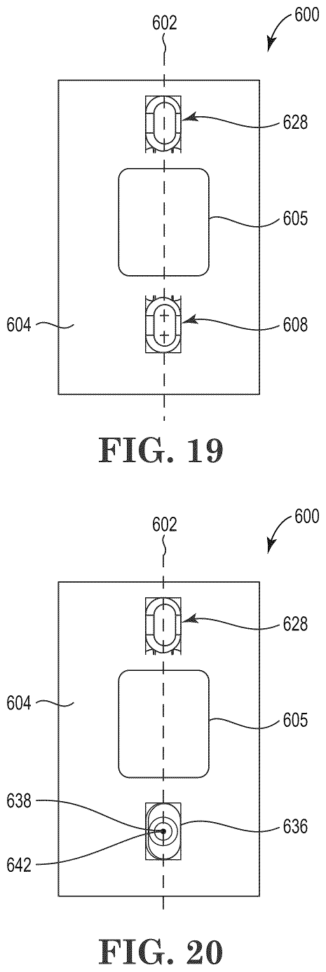

The second fenestration unit component 500 is configured for adjustment along the second adjustment axis 502 using any suitable technique. For example, at least one of the first fastener opening 508 or the second fastener opening 528 can be configured to receive a fastener (e.g., first or second fasteners 546, 547 of FIG. 18), where the elongated opening 522 of the first fastener opening and/or the elongated opening 530 of the second fastener opening are sized so that the fastener can be fastened to the base 504 in multiple positions within these openings. As a result, the component 500 can be configured to be adjusted along the adjustment axis 502 relative to the fenestration unit frame member 506 upon which the base 504 is disposed or located, while a fastener 546 disposed in the first fastener opening 508 can remain aligned with a pre-drilled datum disposed in a second fenestration unit frame member 506 (FIG. 19).

As shown in FIG. 16, the first fenestration unit component 100 is configured for adjustment along the first adjustment axis 102 and the second fenestration unit component 500 is configured for adjustment along the second adjustment axis 502. In one or more embodiments, the first adjustment axis 102 is substantially orthogonal to the second adjustment axis 502. The bottom rail 15 of the first fenestration unit frame member 14 and the top rail 17 of the second fenestration unit frame member 16 can be defined as being aligned along an X-axis, and a Y-axis can be defined as orthogonal to surface 21 of the top rail of the second fenestration unit frame member (i.e., orthogonal to the plane of FIG. 16). Further, a Z-axis can be defined as orthogonal to the X-and Y-axes. As shown in FIG. 16, the first adjustment axis 102 is parallel to the X-axis, and the second adjustment axis 502 is parallel to the Z-axis.

As shown in FIG. 17, the second fenestration unit component 500 includes the first placement insert 536-1 and the second placement insert 536-2. The first placement insert 536-1 can be located and retained in the first fastener opening 508, and the second placement insert 536-2 can be located and retained in the second fastener opening 528. Although depicted as including two placement inserts, the component 500 can include a single placement insert configured to be located in at least one of the first fastener opening 508 or the second fastener opening 528. In one or more embodiments, at least one of the first or second placement inserts 536-1 and 536-2 can be releasably retained within its respective opening 508, 528 using any suitable technique. In one or more embodiments, at least one of the first or second placement inserts 536-1 and 536-2 can be retained within its respective opening 508, 528 by friction between the placement insert and the fastener opening. In one or more embodiments, at least one of the first or second placement inserts 536-1 and 536-2 can be retained within its respective opening 508, 528 by a mechanical interlock (not shown) between the placement insert and the fastener opening.

The base 504 can be configured for attachment to any suitable fenestration unit frame member or sash 106 (FIG. 16). For example, the base 504 can be configured for attachment to the fenestration unit frame member or sash 16 of FIGS. 1-2.

The base 504 can take any suitable shape and have any suitable dimensions. As shown in FIG. 18, the base 504 includes a lower surface 548 and an upper surface 550. The lower surface 548 can be configured to face the fenestration unit frame member 506. Further, the upper surface 550 of the base 504 can be configured to face away from the member 106.

The base 504 can include any suitable material, e.g., the same materials described herein regarding base 104 of first fenestration unit component 100.

Extending through the base 504 is the first fastener opening 508 and the second fastener opening 528. The first and second fastener openings 508, 528 can each take any suitable shape and have any suitable dimensions, e.g., the same shape and dimensions described herein regarding first and second fastener openings 108, 128 of first fenestration unit component 100. As shown in FIG. 16, the elongated opening 522 of the first fastener opening 508 includes the major axis 524 and the minor axis 526. The major axis 524 is longer than the minor axis 526. In one or more embodiments, the major axis 524 can be substantially orthogonal to the opening axis 503. In one or more embodiments, the minor axis 126 can be substantially parallel with the opening axis 503. In one or more embodiments, either the major axis 524 or the minor axis 526 can be colinear with the opening axis 503. In the embodiment illustrated in FIG. 16, the minor axis 526 is colinear with the opening axis 503.

Also extending through the base 104 is the second fastener opening 128, which includes the elongated opening 130. The elongated opening 130 can take any suitable shape and have any suitable dimensions, e.g., the same shapes and dimensions described herein regarding the elongated opening 522 of the first fastener opening 508. In the embodiment illustrates in FIGS. 15-18, the second fastener opening 528 (i.e., the elongated opening 530) defines a stadium shape on the upper surface 550 of the base 504.

Each of the first and second fastener openings 508, 528 can be disposed in any suitable portion or portions of the base 504. As shown in FIG. 16, the first fastener opening 508 and the second fastener opening 528 are aligned with each other along the opening axis 503, where the opening axis extends through the first fastener opening and the second fastener opening. Further, the first fastener opening 508 can be disposed any suitable distance from the second faster opening 528 along the opening axis 503. As shown in FIG. 17, a portion 511 of the handle 510 that connects to the cam 512 and that is configured to rotate the cam so that it engages with the receiver portion 172 of the first fenestration unit component 100 is disposed between the first fastener opening 508 and the second fastener opening 528 along the opening axis 503.

As mentioned herein, each of the first fastener opening 508 and the second faster opening 528 can take or define any suitable shape. In one or more embodiments, the first fastener opening 508 and the second fastener opening 528 include the same shape. For example, the first fastener opening 508 and the second fastener opening 528 can each define a stadium shape on the upper surface 550 of the base 504. As shown in FIG. 16, the stadium shape of the first fastener opening 508 and the stadium shape of the second fastener opening 528 are symmetric relative to the opening axis 503. In one or more embodiments, the first fastener opening 508 can define a shape that is different from a shape defined by the second fastener opening 528.

Each of the first and second fastener openings 508, 528 can taper to a first passage formed through the base 504 when moving from the upper surface 550 towards the lower surface 548 of the base. For example, FIG. 18 is a schematic cross-section view of the first fastener opening 508 with the first placement insert 536-1 located in the first fastener opening. In one or more embodiments, a first passage 554 can be symmetric related to the opening axis 503. A fastener axis 544 of the first placement insert 536-1 can form any suitable angle with the surface 507 of the fenestration unit frame member 506. In one or more embodiments, the fastener axis 544 can be substantially orthogonal to the surface 507.

Each of the first and second fenestration unit components 100, 500 can be adjusted during at least one of manufacture or installation so that the fenestration lock system 518 can lock the first fenestration unit frame member 14 and the second fenestration unit frame member 16 in their closed positions. For example, the first fenestration unit component 100 can be configured to engage the second fenestration unit component 500 to lock the frame members 14, 16 in the closed position, e.g., the cam 512 of the second fenestration unit component 500 can be rotated utilizing the handle 510 so that it engages with the receiver portion 172 of the first fenestration unit component 100 and locks the fenestration unit frame members so that they are unable to be disposed relative to each other along the Y-axis.

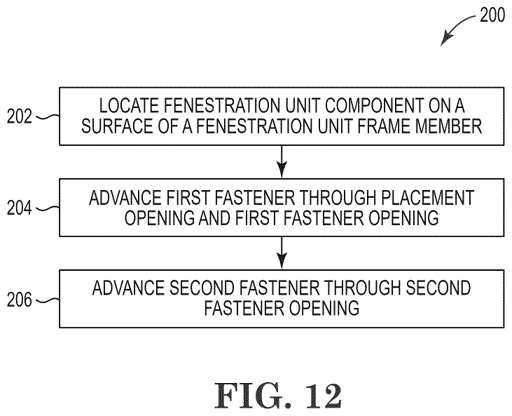

Any suitable technique can be utilized to attach the fenestration unit component 100 to a surface or substrate, e.g., fenestration unit frame member 106. For example, FIG. 12 is a flowchart of one embodiment of a technique 200 for attaching the fenestration unit component 100 to the surface of the fenestration unit frame member 106. Although described regarding fenestration unit component 100 of FIGS. 3-11, the technique 200 can be utilized with any suitable fenestration unit component or other unit component described herein.

At 202, the fenestration unit component 100 can be located on the surface 107 of the fenestration unit frame member 106 using any suitable technique. In one or more embodiments, the fenestration unit component 100 can be located on the surface 107 (FIG. 4) of the fenestration unit frame member 106 by aligning the placement opening 138 of the placement insert 136 with a selected location 186 (e.g. a datum) on the fenestration unit frame member before advancing the first fastener 146. Any suitable technique can be utilized to indicate the location 186 on the fenestration unit frame member 106. In one or more embodiments, the selected location 186 can be aligned with the midpoint 184 of the major axis 124 of the first fastener opening 108. The placement opening 138 of the placement insert 136 can be aligned with the selected location in 186 by aligning the fixed center 142 of the placement opening with the selected location. As mentioned herein, the fixed center 142 of the placement opening 138 can be located proximate the midpoint 184 of the major axis 124 of the first fastener opening 108.

At 204, the first fastener 146 can be advanced through the placement opening 138 of the placement insert 136 using any suitable technique as shown in FIG. 9, where the first fastener is advanced through the placement opening and the first fastener opening 108 into the fenestration unit frame member 106, which can be the surface 21 of the fenestration unit frame member 14 of the fenestration unit 10 of FIGS. 1-2. In one or more embodiments, the first fastener 146 can be advanced along the fastener axis 144 that extends through the fixed center 142 of the placement opening 138.

At 206, the second fastener 147 can be advanced through the second fastener opening 128 using any suitable technique. In one or more embodiments, the second fastener 147 is advanced through the second fastener opening 128 after the first fastener 146 is advanced through the placement opening 138 of the placement insert 136 and the first fastener opening 108. In one or more embodiments, the placement insert 136 is a first placement insert, and the second fastener can be advanced through the second fastener opening 128 by advancing the second fastener through a placement opening of a second placement insert and the second opening. For example, the second fastener 547 of the second fenestration unit component 500 of FIG. 17 can be advanced through the placement opening of the second placement insert 536-2 and the second opening 528 of the second fenestration unit component.

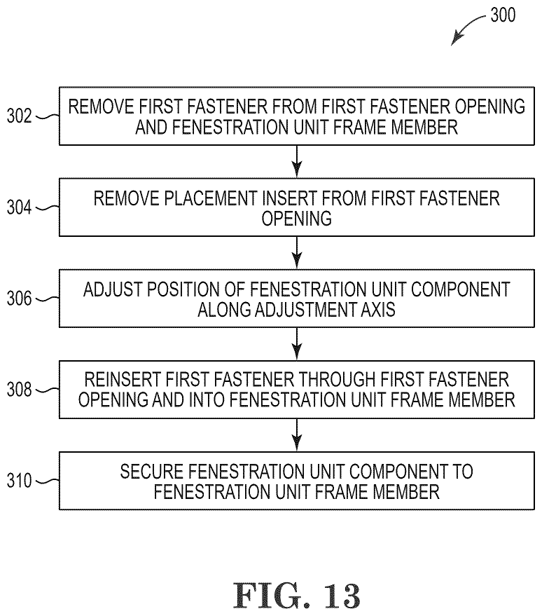

The position of the fenestration unit component 100 on the surface of the fenestration unit frame member 106 can be adjusted using any suitable technique. For example, FIG. 13 is a flowchart of one technique 300 for adjusting the position of the fenestration unit component 100. Although described regarding fenestration unit component 100 of FIGS. 3-11, the technique 300 can be utilized with any suitable fenestration unit component or other type of unit component described herein. At 302, the first fastener 146 can be removed from the first fastener opening 108 and the fenestration unit frame member 106 using any suitable technique. For example, the first fastener 146 can be removed from the first fastener opening 108 by removing the first fastener from the placement opening 138 of the placement insert 136 that is located in the first fastener opening.

At 304, the placement insert 136 can be removed from the first fastener opening 108 after removing the first fastener 146 from the first fastener opening using any suitable technique. For example, in one or more embodiments, the placements insert 136 can be removed by pushing the placement insert out of the first fastener opening 108. Further, in one or more embodiments, the placement insert 136 can be removed by prying the placement insert out of the first fastener opening 108 using any suitable technique. For example, a screwdriver can be inserted into the placement opening 138 or under an edge of the placement insert 136 to pry the placement insert out of the first fastener opening 108. In one more embodiments, the first fastener 146 can be inserted into the placement insert 136 and used to pry the insert from the first fastener opening 108. Further, for example, the placement insert 136 can be removed by releasing the mechanical interlock 188 that is disposed between the placement insert and the base 104. Following removal of the first fastener 146 and the placement insert 136 from the first fastener opening 108, the second fastener 147 can be loosened or removed from the unit frame member 106 using any suitable technique before adjusting the position of the fenestration unit component 100 along the adjustment axis 102. In one or more embodiments, the placement insert 136 can be a first placement insert, and the second fastener 147 can be removed from the placement opening of a second placement insert (e.g., second placement insert 536-2 of FIG. 17) that is located in the second fastener opening (e.g., second fastener opening 528 of FIG. 17).

The position of the fenestration unit component 100 can be adjusted along the adjustment axis 102 at 306 using any suitable technique. Further, at 308, the first fastener 146 can be reinserted through the first fastener opening 108 and into the fenestration unit frame member 106 using any suitable technique. For example, the first fastener 146 can be reinserted through the first fastener opening 108 and into the fenestration unit frame member 106 by reinserting the first fastener into a bore 190 in the fenestration unit frame member (FIG. 9) from which the first fastener was removed when removing the first fastener from the first fastener opening 108 and the fenestration unit frame member. Further, the fenestration unit component 100 can further be secured to the fenestration unit frame member 106 using any suitable technique at 310 after the position of the fenestration unit component has been adjusted, e.g., the second fastener 147 can be directed through the second fastener opening 128 and into the fenestration unit frame member 106 using any suitable technique.

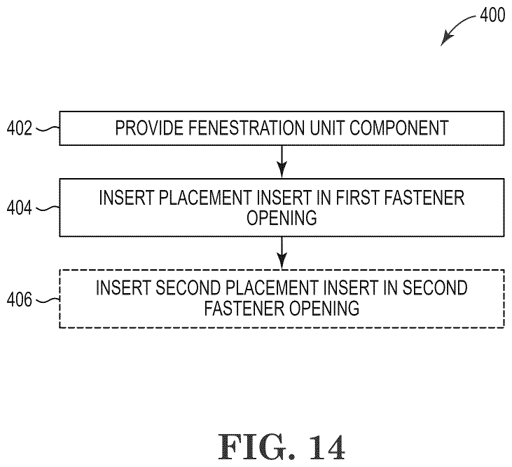

Any suitable technique can be utilized to assemble the various embodiments of fenestration unit components described herein. For example, FIG. 14 is a flowchart of one embodiment of a technique 400 for assembly the fenestration unit component 100. Although described regarding fenestration unit component 100, the technique 400 can be utilized to assembly any suitable fenestration unit component. At 402, the fenestration unit component 100 is provided. At 404, the placement insert 136 is inserted into the first fastener opening 108 using any suitable technique. A second placement insert (e.g., second placement insert 536-2 of FIG. 18) can optionally be inserted in the second fastener opening 128 at 406 using any suitable technique.

As mentioned herein, the fenestration unit component 100 can be utilized in any suitable application that may require adjustment of the component during installation and after the component has been installed during manufacture. In one or more embodiments, the fenestration unit component 100 can be a keeper, lock assembly, strike plate of a locking unit or lock set, casement hinge hardware, casement snubber hardware, etc., as is further described herein,

For example, FIGS. 19-20 are schematic plan views of one embodiment of a lock unit component 600. The lock unit component 600 can include any suitable fenestration unit component described herein. All of the design considerations and possibilities described herein regarding the fenestration unit component 100 of FIGS. 3-11 and any techniques described herein regarding FIGS. 12-14 apply equally to the locking unit component 600 illustrated in FIGS. 19-20 unless stated otherwise. In one or more embodiments, the lock unit component 600 can be a strike plate that is a component of a lock set for a door, window, cabinet, etc.

The lock unit component 600 can be configured for adjustment along an adjustment axis 602 and includes a base 604 that is configured for attachment to a substrate, e.g., a door jamb or a door frame. The component 600 also includes a first fastener opening 608 extending through the base 604, and a second fastener opening 628 also extending through the base. The unit 600 also includes a placement insert 636 located and retained in the first fastener opening 608 (FIG. 20). The placement insert 636 includes a placement opening 638 defined by fixed center 642 within the first fastener opening 608. The placement insert 636 can include any suitable placement insert described herein, e.g., placement insert 136 of fenestration unit component 100 of FIGS. 3-11.

One difference between lock unit component 600 and fenestration unit component 100 is that the base 604 defines a bolt receiver 605 disposed through the base. The bolt receiver 605 is configured to receive a bolt of a lock set that can be attached to a door or cabinet. The bolt can in turn be configured to extend into the bolt opening 605 and be retained therein when the lock is engaged.

A position of the lock unit component 600 on the substrate (e.g., door frame) can be adjusted using any suitable technique, e.g., one or more of the techniques described herein in reference to FIGS. 12-13. For example, a first fastener can be removed from the first fastener opening 608 using any suitable technique. In one or more embodiments, the first fastener can be removed from the placement opening 638 of the placement insert 636 that is located in the first fastener opening 608. The placement insert 636 can be removed from the first fastener opening 608 after removing the first fastener using any suitable technique. Further, if present, a second fastener that is located in the second fastener opening 628 can be removed from the substrate using any suitable technique. The position of the lock unit component 600 can be adjusted along the adjustment axis 602, and the first fastener can be reinserted through the first fastener opening 608 and into the substrate using any suitable technique. Additionally, the lock unit component 600 can further be secured to the substrate after adjusting the position of the unit using any suitable technique. For example, the second fastener can be reinserted into the second fastener opening 628 and the substrate using any suitable technique and secured to the substrate.

The complete disclosure of the patents, patent documents, and publications identified herein are incorporated by reference in their entirety as if each were individually incorporated. To the extent there is a conflict or discrepancy between this document and the disclosure in any such incorporated document, this document will control.

Illustrative embodiments of fenestration unit components along with related methods are discussed herein with some possible variations described. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof. It should also be understood that this invention also may be suitably practiced in the absence of any element not specifically disclosed as necessary herein.

1. A fenestration unit component configured for adjustment along an adjustment axis, the fenestration unit component comprising:
a base configured for attachment to a fenestration unit frame member;
a first fastener opening extending through the base, the first fastener opening comprising an elongated opening comprising a major axis and a minor axis, wherein the major axis is longer than the minor axis;
a second fastener opening extending through the base, the second fastener opening comprising an elongated opening comprising a major axis and a minor axis, wherein the major axis is longer than the minor axis, wherein the first fastener opening and the second fastener opening are aligned with each other along an opening axis extending through the first fastener opening and the second fastener opening; and
a placement insert located and retained in the first fastener opening, the placement insert comprising a placement opening defining a fixed center within the first fastener opening, wherein the placement opening is smaller than the first fastener opening, and wherein the placement opening defines a fastener axis extending through the fixed center of the placement opening.

2. A fenestration unit component according to claim 1, wherein the placement insert is releasably retained in the first fastener opening.

3. A fenestration unit component according to claim 1, wherein the placement insert is retained in the first fastener opening by friction between the placement insert and the first fastener opening.

4. A fenestration unit component according to claim 1, wherein the placement insert is retained in the first fastener opening by a mechanical interlock between the placement insert and the first fastener opening.

5. A fenestration unit component according to claim 1, wherein the first fastener opening and the second fastener opening comprise different shapes such that the placement insert cannot be located and retained in the second fastener opening.

6. A fenestration unit component according to claim 1, wherein the base comprises a lower surface and an upper surface, wherein the lower surface is configured to face the fenestration unit frame member and the upper surface is configured to face away from the fenestration unit frame member, and wherein the first fastener opening and the second fastener opening each define a stadium shape on the upper surface of the base.

7. A fenestration unit component according to claim 6, wherein the first fastener opening tapers to a first passage formed through the base when moving from the upper surface towards the lower surface, and wherein the first passage is asymmetric relative to the opening axis.

8. A fenestration unit component according to claim 6, wherein the second fastener opening tapers to a second passage formed through the base when moving from the upper surface towards the lower surface, and wherein the second passage is symmetric relative to the opening axis.

9. A method of adjusting a position of a fenestration unit component on a surface of a fenestration unit frame member, the fenestration unit component comprising an elongated first fastener opening extending through a base, and an elongated second fastener opening extending through the base, the method comprising:
removing a first fastener from the first fastener opening and the fenestration unit frame member, wherein removing the first fastener from the first fastener opening comprises removing the first fastener from a placement opening of a placement insert located in the first fastener opening;
removing the placement insert from the first fastener opening after removing the first fastener from the first fastener opening;
adjusting a position of the fenestration unit component along an adjustment axis;
reinserting the first fastener through the first fastener opening and into the fenestration unit frame member; and
securing the fenestration unit component to the fenestration unit frame member after adjusting the position of the fenestration unit component.

10. A method according to claim 9, further comprising removing or loosening a second fastener from the second fastener opening prior to adjusting the position of the fenestration unit component.

11. A method according to claim 9, wherein removing the placement insert comprises pushing the placement insert out of the first fastener opening.

12. A method according to claim 9, wherein removing the placement insert comprises prying the placement insert out of the first fastener opening.

13. A method according to claim 9, wherein removing the placement insert comprises releasing a mechanical interlock that is disposed between the placement insert and base.

14. A method according to claim 9, wherein reinserting the first fastener comprises reinserting the first fastener into a bore in the fenestration unit frame member from which the first fastener was removed when removing the first fastener from the first fastener opening and the fenestration unit frame member.

15. A method according to claim 9, wherein the placement insert is a first placement insert, wherein the method further comprises removing a second fastener from the second fastener opening prior to adjusting the position of the fenestration unit component, wherein removing the second fastener from the second fastener opening comprises removing the second fastener from a placement opening of a second placement insert located in the second fastener opening.

16. A fenestration lock system comprising a first fenestration unit component and a second fenestration unit component, wherein the first fenestration unit component is configured for adjustment along a first adjustment axis and the second fenestration unit component is configured for adjustment along a second adjustment axis, wherein the first adjustment axis is substantially orthogonal to the second adjustment axis, wherein each of the first fenestration unit component and second fenestration unit component comprises:
a base configured for attachment to a fenestration unit frame member of a fenestration unit frame;
a first fastener opening extending through the base, the first fastener opening comprising an elongated opening comprising a major axis and a minor axis, wherein the major axis is longer than the minor axis; and
a second fastener opening extending through the base, the second fastener opening comprising an elongated opening comprising a major axis and a minor axis, wherein the major axis is longer than the minor axis, and further wherein the first fastener opening and the second fastener opening are aligned with each other along an opening axis;
wherein the system further comprises a placement insert located and retained in the first fastener opening of at least one of the first fenestration unit component or the second fenestration unit component, the placement insert comprising a placement opening defining a fixed center within the first fastener opening, wherein the placement opening is smaller than the first fastener opening, and wherein the placement opening defines a fastener axis extending through the fixed center of the placement opening.

17. A fenestration lock system of claim 16, wherein the placement insert is a first placement insert, wherein the system further comprises a second placement insert located and retained in the second fastener opening of at least one of the first fenestration unit component or the second fenestration unit component, the second placement insert comprising a placement opening defining a fixed center within the second fastener opening, wherein the placement opening is smaller than the second fastener opening, and wherein the placement opening defines a fastener axis extending through the fixed center of the placement opening.

18. A fenestration lock system according to claim 16, wherein the base of each of the first fenestration unit component and second fenestration unit component comprises a lower surface and an upper surface, wherein the lower surface is configured to face the fenestration unit frame member and the upper surface is configured to face away from the fenestration unit frame member, and wherein the first fastener opening and the second fastener opening each define a stadium shape on the upper surface of the base.

19. A fenestration lock system according to claim 16, wherein the opening axis of the first fenestration unit component is parallel to the adjustment axis.

20. A fenestration lock system according to claim 16, wherein the opening axis of the second fenestration unit component is orthogonal to the adjustment axis.
